(19) United States
(12) Patent Application Publication
(10) Pub. No.: US 2025/0276348 A1
(43) Pub. Date: Sep. 4, 2025

(54) MODULAR DUAL BELT DRIVE UNIT

(71) Applicant: STONEAGE, INC., Durango, CO (US)

(72) Inventors: Jeffery R. BARNES, Ignacio, CO (US); John L. KRAUSER, Durango, CO (US)

(21) Appl. No.: 19/065,511

(22) Filed: Feb. 27, 2025

Related U.S. Application Data
(60) Provisional application No. 63/560,914, filed on Mar. 4, 2024.

(51) Int. Cl. B08B 9/043; B65H 51/10

(52) U.S. Cl. CPC B08B 9/0433; B65H 51/105; B65H 2701/33

(57) ABSTRACT

Disclosed are lance hose drive units having a modular construction for easy disassembly and reassembly of its housing and components. A drive unit includes a housing having front and rear walls, and a top cover coupled to the walls. The housing may include a bottom cover removably also coupled to the front and rear walls, and a motor-side cover coupled to a side edge of at least one of the front wall, rear wall, and top cover. A drive unit may also comprise a belt drive unit positioned within the housing, and configured to drive movement of a lance hose positioned within the housing. A belt-side cover is removably coupled to the top cover, at least one toolless fastener removably securing the belt-side cover. The belt drive unit is slidably coupled at its front end within an interior front channel and at its rear end within an interior rear channel.

### CROSS-REFERENCE TO RELATED APPLICATION

This application claims the benefit of U.S. Provisional Application No. 63/560,914, filed Mar. 4, 2024, entitled “Modular Dual Belt Drive Unit,” the entirety of which is hereby incorporated by reference for all purposes.

### TECHNICAL FIELD

The present disclosure is generally related to the field of high pressure fluid rotary nozzle handling systems, and more particularly to a novel modular nozzle handling unit for use with such handling systems, as well as methods of use and methods of manufacture thereof.

### BACKGROUND

High pressure fluid rotary nozzle handling systems are employed for advancing and retracting one or more flexible tube cleaning lances from tubes arranged in an array, such as in a heat exchanger, from a position adjacent a heat exchanger tube sheet. Advanced systems further include automatically, repetitively reversing forward lance hose feed movement upon encountering an obstruction within a tube or other piping system being cleaned.

One conventional tube lancing unit consists of a rotating reel flexible lance hose take-up and hose dispensing apparatus that carries a predetermined length of flexible lance hose wrapped around a drum. The reel in the drum is rotated by an air motor to push the flexible lance out of the drum and into one or two heat exchanger tubes. The air motor drive can be automatically reversed upon pneumatically sensing a large air pressure increase in air pressure supplied to the forward directional side motor that occurs if the flexible lance being pushed by the reel rotation encounters an obstruction within a tube being cleaned.

As with many types and models of lance hose drive units, failures can occur during use. For example, one or more belt drive units used to move the lance hose(s) through the drive unit may fail, such as the endless belt failing, one or more rollers on a belt drive unit failing, or perhaps the motor driving a belt drive unit failing. Furthermore, a hose being driven by and through the drive unit may become jammed or even broken within the drive unit. Thus, when such a failure occurs, the drive unit must be stopped and taken out of use for service or repair. Additionally, drive units may need to be cleaned, further requiring them to be taken out of use for cleaning. Typically, repairing, servicing, or cleaning a drive unit requires disassembling the drive unit, which traditionally is a long and arduous process. Fasteners such as screws must be removed to open and disassemble the drive unit, as well as to remove and replace or repair components within the drive unit. Doing so is a time-consuming process and requires taking the drive unit out of use for an undesirable amount of time. In some situations, a drive unit in need of repair may even need to be sent to repair facility for disassembly and repair, further increasing the length of time such a drive unit is out of use.

Additionally, components within a drive unit needing repair, cleaning, maintenance, or replacement are typically similarly difficult to remove from the drive unit. Again, such difficult removal of internal components of a drive unit may again cause undesirable delay and downtime for the drive unit. Therefore, what is needed in the art is a hose drive unit and related methods for quickly disassembling and reassembling the drive unit when needed in order to reduce downtime and increase ease of repair or replacement of components within the drive unit. The disclosed principles provide for such a unit and related methods.

### SUMMARY

The disclosed principles provide embodiments of a flexible high pressure fluid cleaning lance tractor drive apparatus or unit having a modular design and construction for quick and easy disassembly and reassembly of the drive unit, its housing, and the components therein. In one embodiment, a drive unit in accordance with the disclosed principles may comprise a housing having a front wall, a rear wall, and a top cover coupled to top ends of the front and rear walls. The housing may also include a bottom cover removably coupled to bottom ends of the front and rear walls, as well as a motor-side cover coupled to a side edge of at least one of the front wall, rear wall, and top cover. The exemplary drive unit may also comprise upper and lower belt drive units positioned within the housing, and configured to drive movement of at least one lance hose positioned between the belt drive units. An actuator is coupled between the top cover and the upper belt drive unit, and configured to provide vertical movement of the upper belt drive unit. A belt-side cover is removably coupled to the upper belt drive unit via at least one fastener, where the belt-side cover is configured to move vertically with the upper belt drive unit via the actuator. In such drive units, the upper and lower belt drive units are slidably coupled at their front ends within a channel formed on an interior surface of the front wall, and at their rear ends within a channel formed on an interior surface of the rear wall, and the bottom cover may also be removably coupled to a bottom edge of the lower belt drive unit providing structural support therefor. Fasteners may be included at lower portions of the front and rear walls sized and configured to retain the belt drive units within the channels on the front and rear walls.

Additional embodiments and advantages and variation thereof are also encompassed within the scope of the disclosed principles, and some such exemplary embodiments discussed in further detail herein.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawing, in which:

FIG. 1 illustrates a perspective view of a conventional flexible lance hose drive system that may include a drive unit designed and constructed in accordance with the disclosed principles;

FIG. 2 illustrates an exemplary embodiment of a multiple lance drive unit in accordance with the disclosed principles;

FIG. 3A illustrates an isometric view of the drive unit of FIG. 2, but viewed from an opposite direction, with the motor-side cover installed;

FIG. 3B illustrates an isometric view of the drive unit of FIG. 3A with the motor-side cover removed;

FIG. 4 illustrates a belt-side view of the drive unit shown in FIGS. 2, 3A and 3B with its upper and lower belt-side covers removed;

FIG. 5 illustrates a partially exploded view of the drive unit shown in FIGS. 2, 3A and 3B, with the upper and lower belt drive units slid out of the housing;

FIG. 6 illustrates an alternative partially exploded view of the drive unit shown in FIGS. 2, 3A and 3B;

FIG. 7 illustrates a sectional view of a rear portion of a drive unit in accordance with the disclosed principles;

FIG. 8 illustrates a sectional view of a bottom portion of the drive unit illustrated in FIG. 7; and

FIG. 9 illustrates a partially transparent view of the belt-side of the drive unit illustrated in FIG. 8.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Although multiple embodiments are shown and discussed in great detail, it will be apparent to those skilled in the relevant art that some features that are not relevant to the present invention may not be shown for the sake of clarity.

As used in this disclosure, the term “rear” refers the inlet end of the drive unit configured to receive one or more flexible lances, and the term “front” refers the outlet end of the drive unit configured to discharge the one or more flexible lances.

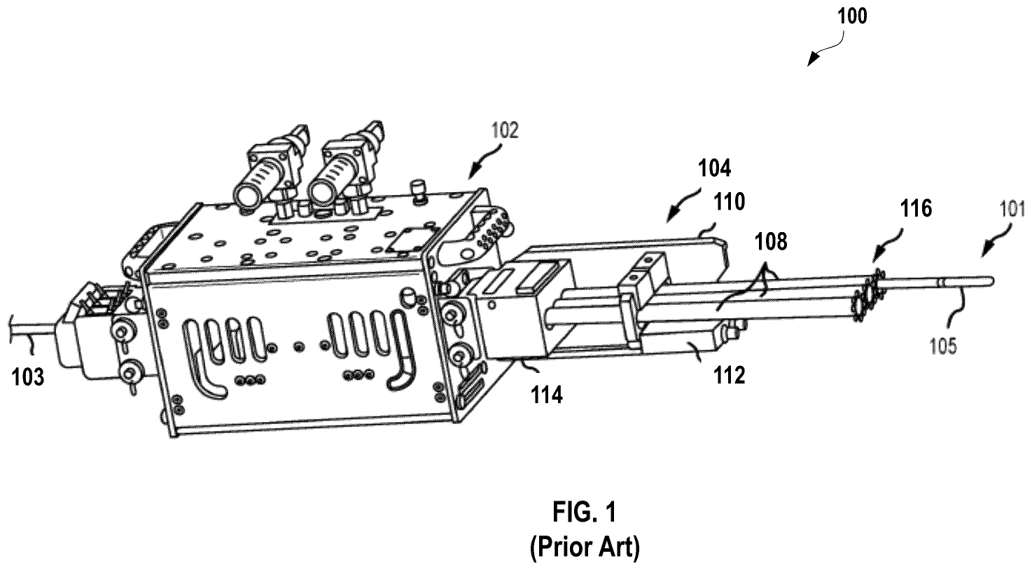

Turning initially to FIG. 1, illustrated is a perspective view of a conventional flexible lance hose drive system 100, and which may include a novel drive unit or apparatus designed and constructed in accordance with the disclosed principles. In this embodiment, the hose drive system 100 includes a hose drive unit 102 and a hose guide assembly 104 coupled to an output end of the hose drive unit 102. The hose drive unit 102 may be configured to drive any number of flexible lances 101, each comprising a lance hose 103 coupled to a nozzle 105. The drive unit 102 may be a one, two, or three lance drive like the illustrated embodiment. The hose drive unit 102 may be replaced with a modular drive unit in accordance with the disclosed principles, while the remainder of the system 100 remains unchanged. As such, a modular unit as disclosed herein can be substituted into existing systems without a need to alter or otherwise adapt existing system components.

The guide assembly 104 includes, in this exemplary embodiment 100, a set of three guide tubes 108 adjustably fastened to a bracket 110 fastened to a trolley (not illustrated) along with a sensor amplifier block 112 beneath the tubes 108 and fastened to the bracket 110. The tractor drive unit 102 is fastened to the bracket 110 via a hose stop collet or crimp encoder block 114 fastened to a rear end of the set of three guide tubes 108. Each of the guide tubes 108 is an elongated cylindrical tube, preferably made of a metal, such as stainless steel, aluminum, brass, a durable plastic, or other rigid material with a high electrical resistivity. An AC pulse sensor 116 is mounted at the distal end of each guide tube 108.

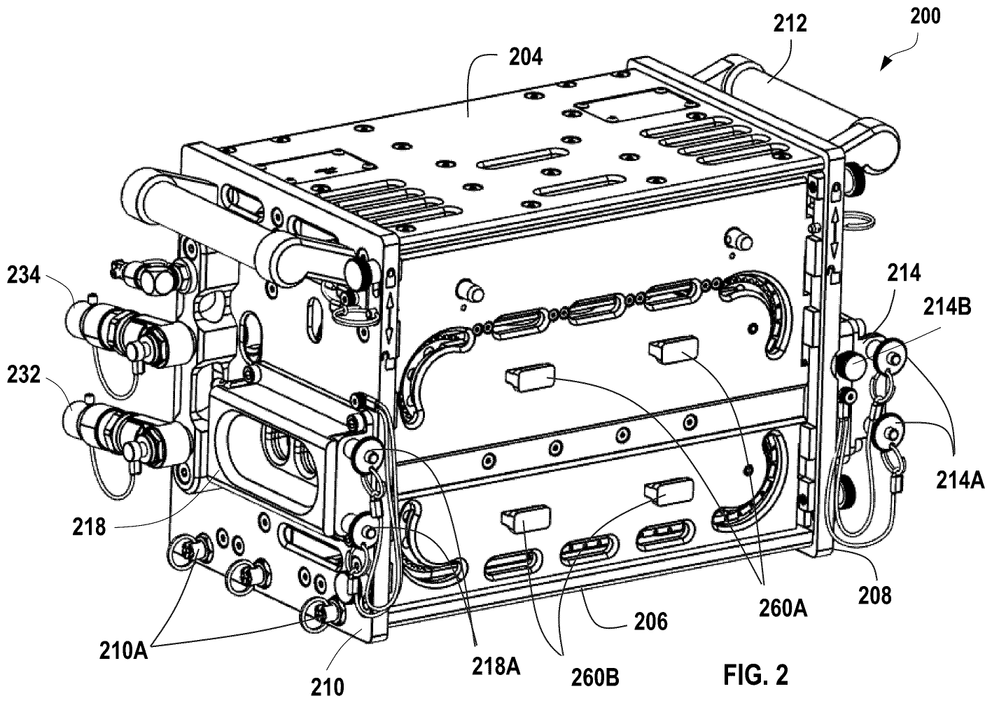

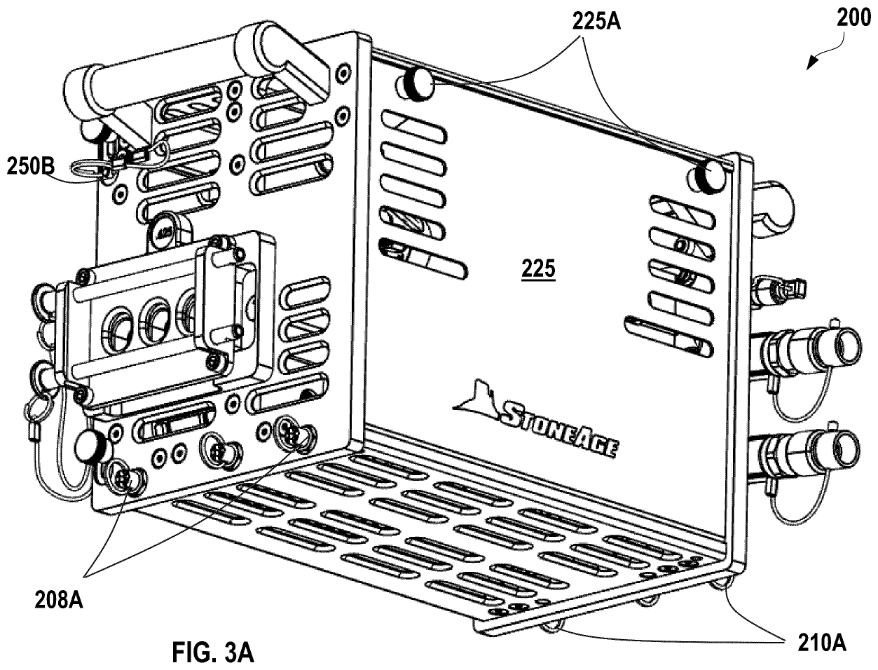

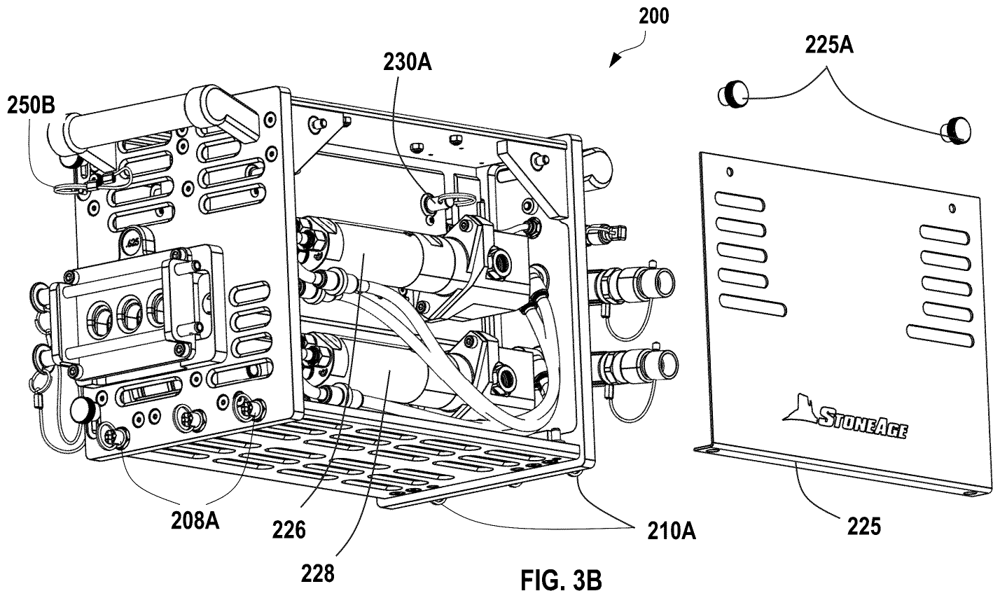

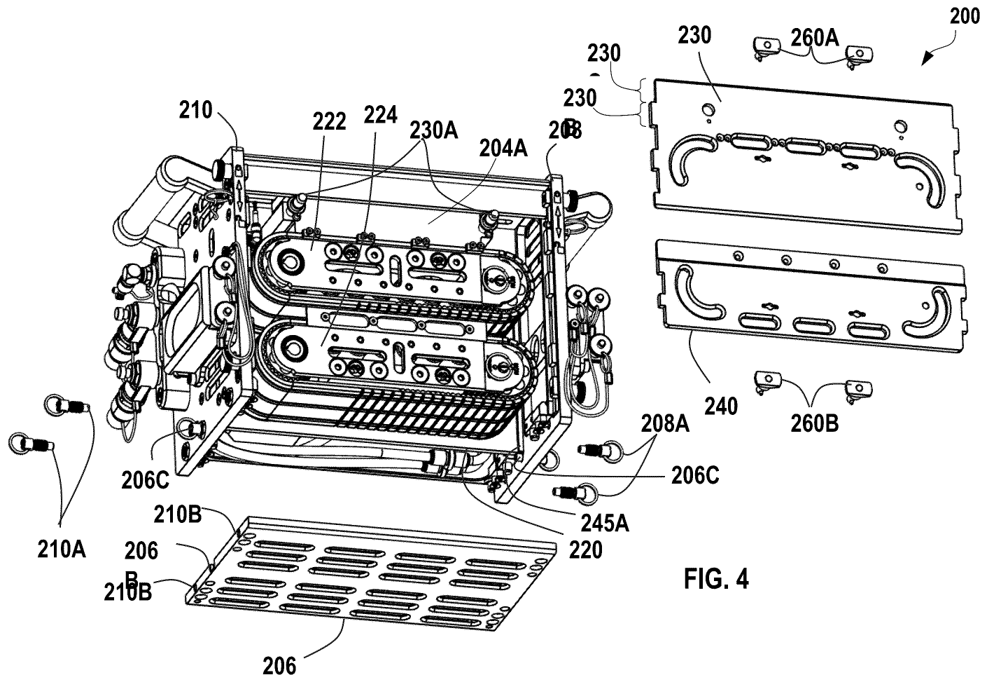

Turning to FIG. 2, illustrated is an exemplary embodiment of a multiple lance, dual belt drive unit 200 in accordance with the disclosed principles. The drive unit 200 is configured to drive flexible high pressure fluid cleaning lance hoses, such as those described with reference to FIG. 1. A belt-side view of the drive unit 200 is shown in FIG. 2 with its removable belt-side covers 230 and 240 in place, while a perspective view of the drive unit 200 with upper and lower outer belt-side covers 230 and 240 removed is shown in FIG. 4. The drive unit 200 has a rectangular box housing that includes, in addition to the belt-side covers 230, 240, a flat top plate or cover 204, a flat bottom plate or cover 206, front and rear walls 208 and 210, respectively, a motor-side cover (see FIG. 3), and two carry handles 212, one on each of the front and rear walls 208 and 210.

Fastened to the front wall 208 is an exit hose guide manifold 214. Fastened to the rear wall 210 below the carry handle 212 is a hose entrance guide manifold 218. Either or both these manifolds 214 and 218 may include a set of hose guide collets for guiding one to three flexible lance hoses (not shown) into and/or out of the housing of the drive unit 200, and onto the belt drive units housed therein and discussed below. Each guide collet set is sized to accommodate a particular lance hose diameter. Hence, the collet sets are changeable depending on the lance hose size to be driven by the drive unit 200. Toolless fasteners 214A and 218A may be provided to secure accessories to respective manifolds 214, 218 to the drive unit 200. Toolless fastener 214B is provided to permit removal/replacement of the collets in the exit guide manifold 214. Permitting such quick, toolless replacement of the collets permits the size of lances used with the drive unit 200 to be easily changed in the field with very little downtime for the unit 200.

Each of the manifolds 214 and 218 includes a sensor, typically a Hall effect sensor (not shown), for detecting the presence or absence of a metal hose stop element that is fastened to each flexible lance hose. These sensors are used to stop the belt drive units in the drive unit 200 when the presence of a hose stop element is sensed. One hose stop element is preferably integrated into the threaded hose ferrule to which a nozzle is attached, at the end of each of the lance hoses. This particular type of hose stop element is configured to prevent inadvertent withdrawal of the flexible lance hose out of the heat exchanger tube sheet and into the drive unit 200. Exemplary sensors and related detection techniques may be seen in U.S. Pat. Nos. 11,441,856 and 11,781,852, which are co-owned with the present disclosure and incorporated herein by reference in their entireties as if reproduced herein. The collection of the entrance guide manifold, corresponding guide collets, and any sensor(s) comprise a hose entrance assembly, and the collection of the exit guide manifold, corresponding guide collets, and any sensor(s) comprise a hose exit assembly.

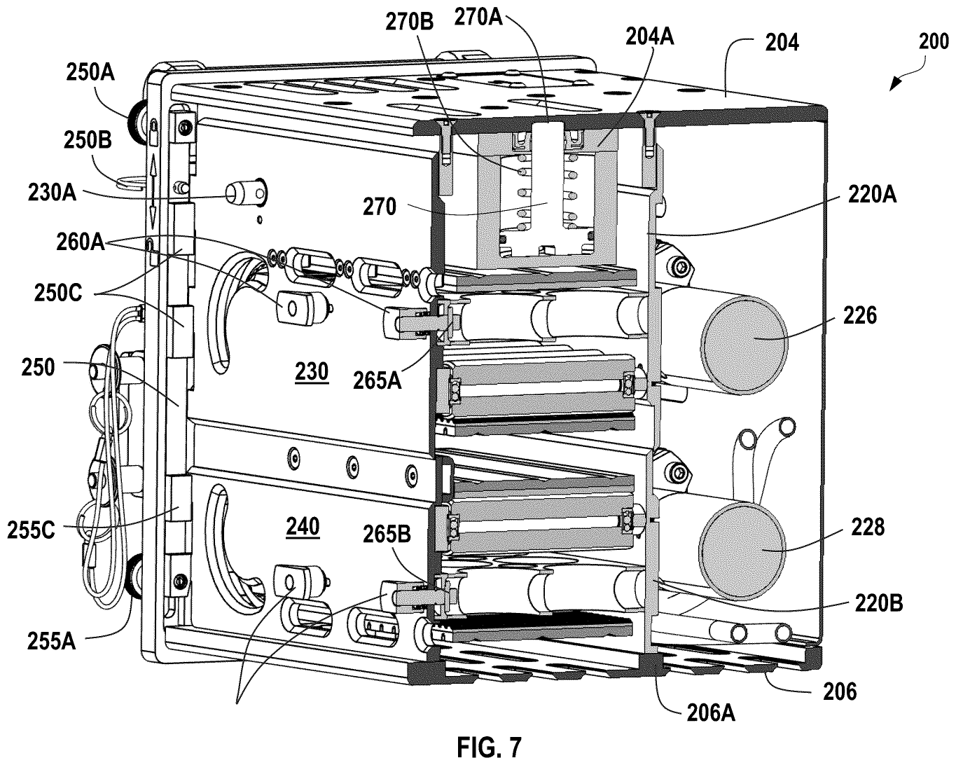

Referring briefly to FIG. 3A, illustrated is an isometric view of the drive unit 200 of FIG. 2, but viewed from an opposite direction. FIG. 3B illustrates an isometric view of the drive unit 200 with the motor-side cover 225 removed. Toolless fasteners, for example, threaded fasteners 225A, may be included on motor-side cover 225 for permitting toolless removal of the motor-side cover 225. In some embodiments, magnetic fasteners may be used in place of threaded fasteners 225A, while in other embodiments, quarter-turn fasteners (such as fasteners 265A, 265B discussed below and illustrated in FIG. 7) may instead be employed. Motor-side cover 225 is illustrated in the uninstalled position, and removal of this cover 225 permits access to one or more motors 226, 228, as well as access to one or more fasteners 230A (see FIG. 4).

Looking now at FIG. 4, illustrated is a belt-side view of the drive unit 200 shown in FIGS. 2 and 3 with its upper and lower belt-side covers 230, 240 removed. The upper and lower belt-side covers 230, 240 are designed and constructed so as to structurally connect together when installed on the drive unit 200 (specifically, a bottom edge of the upper cover 230 is configured to structurally but removably engage a top edge of the lower cover 240), and the upper cover 230 is removably affixed to the drive unit 200 via cover mounting pins 230A. The mounting pins 230A may also be employed to structurally connect the upper belt drive unit 222 to the clamping mechanism 204A, which as described in detail below is used to vertically move the upper belt drive unit 222 within the unit 200 to clamp lance hoses positioned and fed between the upper and lower belt drive units 222, 224.

In exemplary embodiments, the top cover 204 is secured to the top ends of both the front and rear walls 208, 210 with fasteners requiring tools, such as screws. Additionally, internal structural components may similarly be secured to these components with such tool-requiring fasteners. The securing of the top cover 204 to the front and rear walls 208, 210, as well as any internal structure, in this manner provides a sturdy base structure for the drive unit 200 that is maintained while other components are configured as removable from this base structure in the quick-disconnect, tool-free manner disclosed herein. Pins or other fastening devices may be removably connected to ends of the mounting pins 230A to secure the upper belt-side cover 230 to the drive unit 200. Alternatively, ends of the pins 230A may include fastening devices, such as spring-loaded tabs, pins, or similar toolless device that removably engage and release the upper cover 230.

The drive unit 200 includes an inner vertical support wall 220 removably fastened to the front and rear walls 208 and 210, and the top and bottom plates 204 and 206. This vertical support wall 220 is part of the upper and lower belt drive units 222, 224, and may be part of, or comprise the entirety of, the internal vertical support structure in embodiments of the drive unit 200 having such a structure. This vertical support wall 220 divides the housing of the drive unit 200 and the belt drive units 222, 224 into a belt-side portion and a motor-side portion. The motor-side portion primarily houses hose fittings and belt drive motors 226 and 228, along with any needed wiring, controllers, etc. The belt-side portion is a belt cavity through which flexible lance hoses (not shown) are driven by the endless belts disposed on the upper and lower drive belt units 222 and 224, respectively, when fed therebetween.

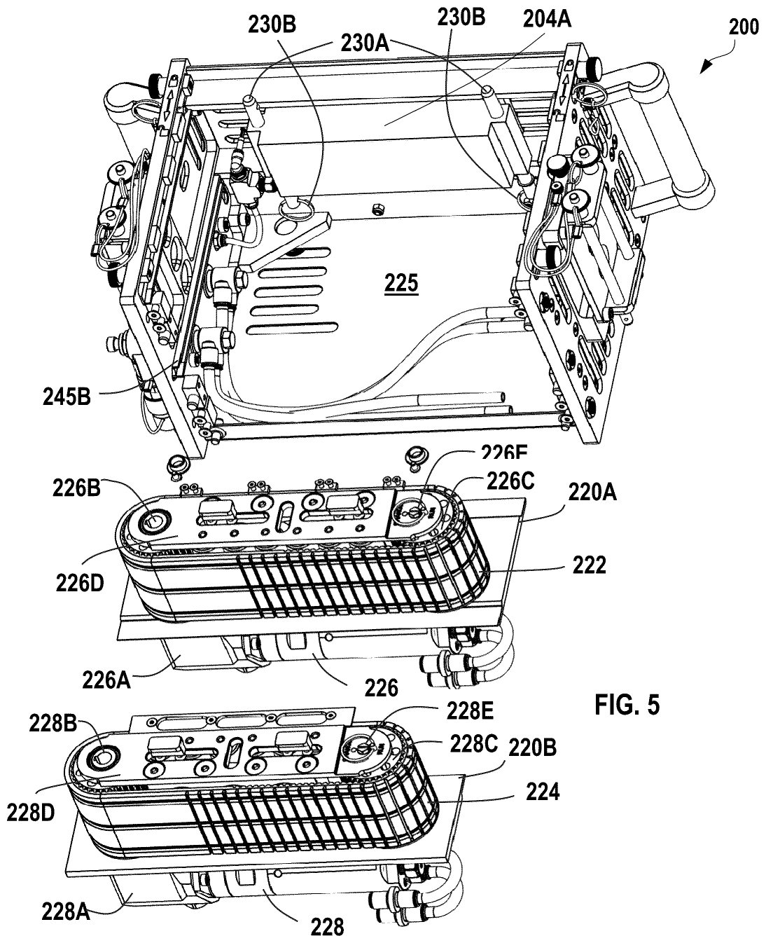

In this exemplary embodiment of drive unit 200, the inner vertical support wall 220 is shown to be formed in two interconnected parts, an upper part 220A and a lower part 220B (collectively 220), as seen in FIG. 5. FIG. 5 illustrates a partially exploded view of the drive unit 200, with the upper and lower belt drive units 222, 224 slid out of the housing. A separate upper support wall 220A aligned with and removably connected to the lower support wall 220B provides a rigid, structural joint between the front and rear walls 208 and 210, as well as the top plate 204, and optionally in some embodiments with the bottom plate 206 as well. The structural connection between the upper and lower support walls 220A, 220B and various components of the housing is described in further detail below. Each of the support walls 220A, 220B is preferably a flat plate of a lightweight material such as aluminum, or could be made of a structural polymer with sufficient strength and rigidity to handle the motor operational stresses involved.

Each of the support walls 220A, 220B carries a drive motor 226 and 228, respectively, mounted such that their drive shafts 226A, 228A protrude laterally through each of the support walls 220A, 220B into the belt-side portion and into a drive end of the upper and lower drive belt units 222, 224. Each of the drive motors 226 and 228 has a dominant length dimension that is aligned in parallel with the belts of the belt drive units 222, 224, and thus each includes a gearbox 226A, 228A to transfer and redirect the rotation of the drive shaft of each motor into drive rollers 226B, 228B onto which belts of the belt drive units 222, 224 are mounted. Such parallel alignment of the motors 226, 228 with the belt drive units 222, 224 permits a more compact overall construction of the drive unit 200 and allows each of the drive motors 226 and 228 to be housed entirely within the housing of the drive unit 200. Each of the drive motors 226, 228 is connected to pneumatic forward feed line 234 and reverse feed line 232 (see FIG. 2) through a feed manifold fastened to the rear plate 210. Each of the drive motors 226 and 228 shown in FIG. 5 is preferably a compact vane gearmotor with integral planetary gear reduction driving a bevel gearbox. Alternatively, radial piston pneumatic, hydraulic or electric motors could be used.

Importantly, the distal ends of each of the drive shafts 226A and 228A terminate before reaching the belt-side support covers 230, 240, and those drive shafts are laterally supported from the respective upper and lower support plates 220A, 220B. Such centralized support within the interior of the drive unit 200 permits the outer side walls of the drive unit 200 to be removed without affecting the structural integrity of the drive belt units 222, 224 and their respective drive motors 226, 228. A separate bearing supported shaft also extends out of, and is supported by, respective upper and lower support plates 220A, 220B, and on which each roller of the drive belts 222, 224 is supported. For example, spaced between each splined drive roller 226B, 228B at the drive end of each of the drive belt units 222, 224, and corresponding splined idler rollers 226C, 228C opposite the drive rollers, are cylindrical guide rollers (not visible) that are also supported by the respective upper and lower support plates 220A, 220B via shafts extending therefrom and terminating in outer side plates 226D, 228D of each belt drive unit 222, 224. The outer surface portion or cover of the endless belts on the drive belt units 222, 224 may be flat and smooth to prevent undesirable hose abrasion and degradation as they drive lance hoses between them and are formed of a suitable friction material such as polyurethane. In other embodiments, the belts may have circumferential grooves (e.g., 3 grooves if 3 hoses are to be driven) to stabilize the hoses while contacting the belts to resist buckling of smaller hose sizes. Such belts may also have perpendicular grooves (sipes) on, for example, a 10 mm pitch to help shed debris from the outer diameters of the hoses during use. The idler rollers 226C, 228C may be slid forward or backward to tighten or loosen, respectively, the endless belts of the belt drive units 222, 224. Tensioner pins 226E, 228E may be provided to tighten or release the idler rollers 226C, 228C in order to tighten or loosen the belts. These tensioner pins 226E, 228E may again be toolless so as to facilitate quick field disassembly of the unit 200, and in particular replacement of the belts on the belt drive units 222, 224, in the manner described herein.

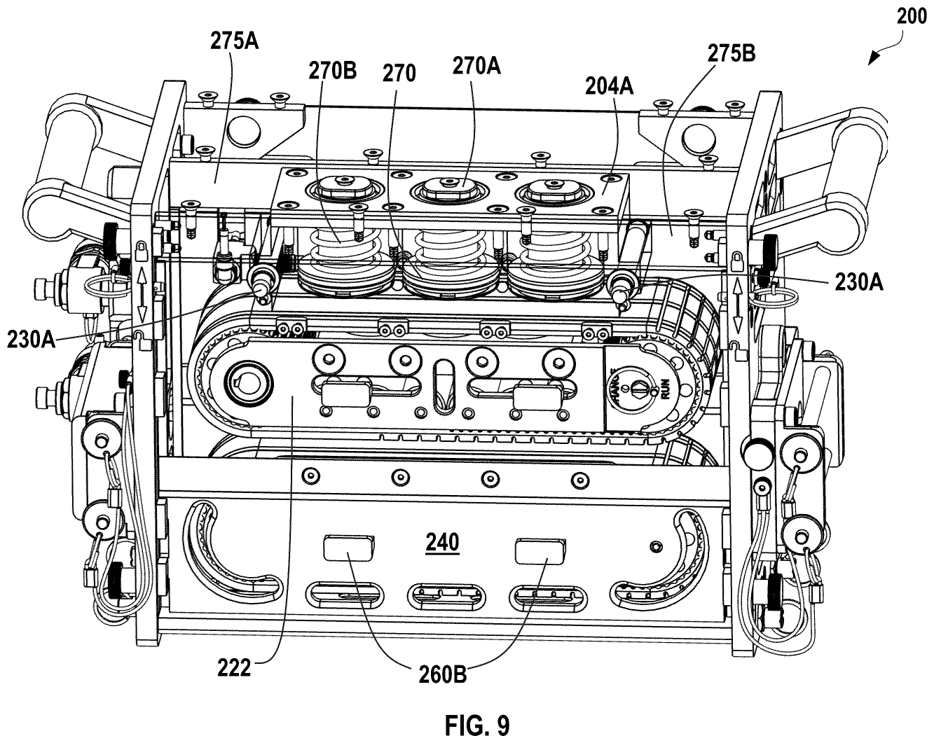

A vertical actuator, which in this embodiment is pneumatic clamping mechanism 204A, attaches to the top plate 204 with fasteners, such as flathead screws, and attaches to the upper belt drive assembly 222 with pins 230A, as described above. The clamping mechanism 204A moves the upper belt drive assembly 222 in relation to the lower belt drive assembly 224 to allow multiple lance hose sizes to be used with drive unit 200. Adjusting the clamping pressure provided by the clamping mechanism 204A also controls the amount of clamping force on the hoses and the resulting traction transmitted from the belts on the upper and lower belt drive units 222, 224 to the cover of the hose(s) employed with the drive unit 200. The clamping mechanism 204A is described in further detail below with reference to FIG. 9.

Also illustrated in FIG. 5 is a component of the interior support structure formed vertically along an interior of the rear wall 210. In this embodiment, this component of the support structure is a channel 245B formed vertically along a substantial length of the rear wall 210. The interior of the front wall 208 includes a corresponding channel 245A disposed thereon, and partially visible in FIG. 4. The front wall channel 245A is sized to slidably receive the front edges of the upper and lower support walls 220 therein, while the rear wall channel 245B is sized to slidably receive the rear edges of the upper and lower support walls 220 therein. Moreover, the channels 245A, 245B are sized such that, despite permitting a slidable connection with the front and rear edges, respectively, of the upper and lower support walls 220, the placement of the support walls 220 within the channels 245A, 245B, as well as their connection to one another, still provides structural integrity within the housing, and thus the drive unit 200 as a whole. This is important since, as discussed above, the belt drives 222, 224 are carried on and structurally supported by the support walls 220, and thus the channels 245A, 245B assist in proving structural integrity between the belt drive units 222, 224 and the other components of the housing, in particular the top cover 204 and the front and rear walls 208, 210 adjoined thereto with tooled fasteners.

The top edge of the upper support wall 220A may also removably engage with one or more structures formed on an interior surface of the top cover 204. In this embodiment, one or both of toolless fasteners 230A may be used to secure the upper support wall 220A via one or more corresponding apertures formed therethrough to an interior of the top of the housing. This in turn secures the upper belt drive unit 222 within the drive unit 200. Removal of the motor-side cover 225 can permit access to fasteners 230A, which may be pulled by handles 230B to release the upper belt drive unit 222 and to optionally remove the belt side cover 230.

Additionally, a bottom edge of the lower support wall 220B may also removably engage with one or more structures formed on an interior surface of the bottom cover 206 to further provide structure to the drive unit 200. In particular, in some embodiments, the interior surface of bottom cover 206 includes a channel 206A (shown in FIG. 7) formed therein or thereon and extending longitudinally at least partially between its front end to its rear end. This channel 206A may be sized to removably receive a bottom edge of the lower support wall 220B therein, and is sized such that, despite permitting a slidable connection with the bottom edge of the lower support wall 220B and the bottom cover 206, the placement of the lower support wall 220B within the channel 206A still provides structural integrity within the housing, and thus the drive unit 200 as a whole. Specifically, structural integrity is provided between top and bottom covers 204, 206 and the upper and lower walls 220A, 220B.

Alternatively or as part of the channel 206A, two end channels 206B, with one formed at each of the front and rear ends of the bottom cover 206, may instead be sized to receive first and second toolless fasteners 206C respectively located through bottom ends of the front and rear walls 208, 210. In exemplary embodiments, one of these fasteners 206C passes through a bottom end of the front wall 208 at a terminal end of the channel 245A located on the interior of the front wall 208, and the other of these fasteners 206C passes through a bottom end of the rear wall 210 at a terminal end of the channel 245B on the rear wall 210. These toolless fasteners 206C are positioned in the front and rear walls at these locations to prevent sliding withdrawal of the lower support wall 220B of the lower belt drive unit 224 from within the channels 245A, 245B on the front and rear walls respectively. In such embodiments, the channels 206B in the bottom cover 206 are formed to provide room for the fasteners 206C when the bottom cover 206 is affixed to the drive unit 200. As with other toolless fasteners disclosed herein, fasteners 206C may include handles with which to pull the fasteners 206C from within corresponding apertures formed in the front and rear walls 208, 210 to permit sliding out of the upper and lower support walls 220 from the front and rear channels 245A, 245B. However, in some embodiments, the fasteners 206B may also be spring-loaded so that when pulled, the fasteners 206B permit sliding out of the upper and lower support walls 220 from the front and rear channels 245A, 245B, and then they return to their original position when the handles are released.

Additional toolless fasteners providing removable coupling of various components of the drive unit 200 may also be included to permit the quick, toolless disassembly of operative components of the drive unit 200 as disclosed herein. For example, illustrated in FIGS. 2, 3 and 4 are pull pins 208A configured to pass through corresponding apertures formed through a bottom portion of the front wall 208 (see FIGS. 3 and 4), as well as pull pins 210A configured to pass through corresponding apertures formed through a bottom portion of the rear wall 210 (see FIGS. 2 and 3). Pull pins 210A are sized to be removably received through apertures 210B formed in a rear edge of the bottom cover 206, and pull pins 208A are sized to be removably received through apertures 208B formed in a front edge of the bottom cover 206. As such, pull pins 208A may be quickly removed without the need for any tool from their corresponding apertures formed in the front edge of the bottom cover 206, and pull pins 210A may be similarly removed from their corresponding apertures 210B formed in the rear edge of the bottom cover 206, in order to quickly remove the bottom cover 206. Alternatively, as in other embodiments disclosed herein, the pull pins 208A, 210A may again be spring-loaded so that when pulled, the distal ends of pull pins 208A are removed from the apertures on the front edge of the bottom cover 206, but then remain connected to their respective apertures in the front wall 208. Likewise, in such embodiments, the distal ends of pull pins 210A may be removed from the apertures on the rear edge of the bottom cover 206, but then remain connected to their respective apertures in the rear wall 210.

Once the bottom cover 206 is removed via removal of the pull pins 208A, 210A, each of the pull pins 208A, 210A may then return to their original position until the bottom cover 206 is to be reattached as part of the housing of the drive unit 200. Then, the pull pins 208A, 210A are again pulled until the apertures in the front and rear edges of the bottom cover 206 are aligned with the distal ends of the pull pins 208A, 210A, and the pins reinserted into those apertures. In embodiments where the pull pins 208A, 210A are simply removed from the front and rear walls 208, 210, the respective pull pins 208A, 210A are simply passed back through their corresponding apertures formed at the bottom of the front and rear walls 208, 210, and then into the apertures formed in the front and rear edges of the bottom cover 206. In exemplary embodiments, the distal ends of the pins 208A, 210A are sized for clearance fit within the corresponding apertures in the front and rear edges of the bottom cover 206. Although only two pull pins 208A, 210A are illustrated for securing each of the respective front and rear edges of the bottom cover 206, in other embodiments a greater or fewer number of pull pins may be included.

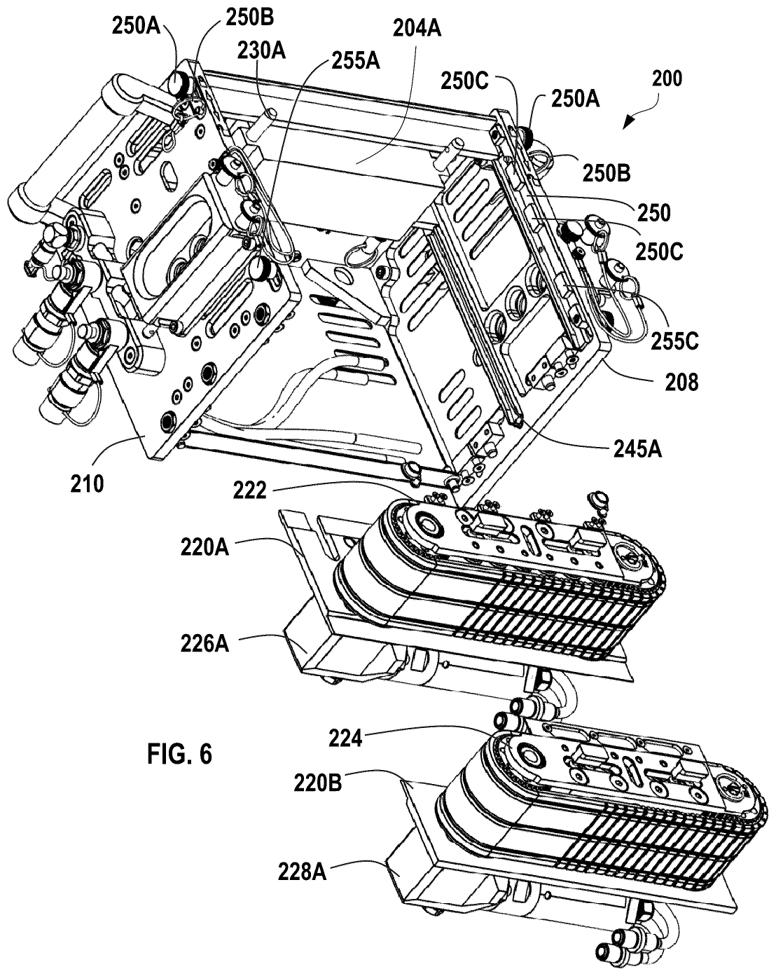

Turning now to FIG. 6, illustrated is an alternative partially exploded view of the drive unit 200 of FIG. 5. Once again, the upper and lower belt drive units 222, 224 are shown removed from the housing of the drive unit 200. From this view, the channel 245A formed along a length of the interior of the front wall 208 is also visible. As discussed in detail above, this channel 245A and the channel 245B formed along a length of the interior of the rear wall 210 are sized and aligned to slidably receive therein the front and rear edges of the upper and lower support walls 220A, 220B. As the support walls 220A, 220B are slid into or out of the drive unit 200, the belt drive units 222, 224 mounted respectively thereon are also movable into and out of the drive unit 200 quickly and easily. As such, one or both of the belt drive units 222, 224 may then be serviced, cleaned, repaired, or replaced, as needed.

Upper toolless fasteners 250A are also visible in the illustration in FIG. 6. These fasteners 250A may be employed in the housing of the drive unit 200 to facilitate securing and removal of the upper belt-side cover 230 of the drive unit 200. Lower toolless fasteners 255A are also visible, and may be used to facilitate securing and removal of the lower belt-side cover 240 from the drive unit 200. To employ the fasteners 250A, 255A to remove these covers 230, 240 of the drive unit 200 housing, the fasteners 250A, 255A may be threaded and thus loosened or altogether removed by unthreading them from their corresponding apertures formed in the front and rear walls 208, 210, and then slidable locks 250 may be moved from a locked to an unlocked position. Alternatively, the fasteners 250A, 255A may be slidably connected to the front and rear walls 208, 210, and thus the fasteners 250A, 255A may be loosened and slid along with the locks 250 from the locked to unlocked position so that the appropriate cover 230, 240 secured by the locks 250 may be removed. Still further, the fasteners 250A, 255A may be pins, such as spring-loaded pins, that may be operated to facilitate removal of the upper and lower covers 230, 240.

Looking back briefly to FIG. 4, notches 230C and corresponding tabs 230B formed on front and rear edges of the upper belt-side cover 230 may be sized to correspond to the position of cams 250C positioned on the slidable locks 250. The alignment of these cams 250C with notches 230C at the upper portion of the upper belt-side cover 230 when the fasteners 250A are loosened so that the slidable locks 250 (see FIGS. 6 and 7) are slid to their unlocked position to permit removal of the cover 230 from the drive unit 200, while the position of the cams 250C when the fasteners 250A tightened once the slidable locks 250 are slid to their locked position can secure the upper cover 230 via tabs 230B (adjacent the notches 230C) as part of the housing. Sliding movement of the slidable locks 250 and upper fasteners 250A between locked and unlocked positions may be configured to solely move the cams 250C from alignment with a notch 230C or tab 230B at the top edge of the upper cover 230. In such embodiments, when the slidable locks 250, and thus the cams 250C, are slid downwardly to the unlocked position, and thus in alignment with a notch 230C proximate the top of the upper cover 230, the cover 230 may be slid upward until additional notches formed along the front and rear edges of the cover 230 are aligned with corresponding additional cams 250C such that the cover 230 may then be laterally removed from the drive unit 200 without the need for any tools. Similarly, the lower fasteners 255A may also include be tightened or loosened to facilitate sliding of the slidable locks 250 (and thus lower cams 255C) where alignment of these lower cams 255C with notches at the lower portion of the lower belt-side cover 240 when the slidable locks 250 are slid to their unlocked position can permit removal of the lower cover 240 from the drive unit 200, while the position of these lower cams 255C when the locks 250 are slid to their locked position can secure the lower cover 240 as part of the housing to retain the lower cover 240 by positioning tabs adjacent to the notches behind the lower cams 255C. While in this embodiment, single slidable locks 250 carry both cams 250C as well as the lower cams 255C such that both the upper and lower covers 230, 240 can be removed simultaneously. In some embodiments, separate slidable locks may be provided so that the covers 230, 240 may be removed separately.

Returning to FIG. 6, toolless lock pull pins 250B may be provided and secured within corresponding apertures to further prevent sliding of the slidable locks 250 when in the locked position, and then when removed, permit sliding of the locks 250 to an unlocked position to permit removal of the appropriate cover 230. As before, the pull pins 250B may also be spring-loaded so that when pulled, the locks 250 may be slid to their unlocked position to permit removal of the upper and lower belt-side covers 230, 240 from the drive unit 200, and then the pins 250B return to their original position when their handles are released. Alternatively, the pins 250B may be pull pins that are simply removed from their respective apertures to permit sliding of the locks 250.

Referring now to FIG. 7, illustrated is a sectional view of a rear portion of a drive unit 200 in accordance with the disclosed principles with the disclosed principles. This view of the drive unit 200 further illustrates toolless securing pins 260A employed to secure the upper belt-side cover 230 to the upper belt-drive unit 222, as well as toolless securing pins 260B employed to secure the lower belt-side cover 240 to the lower belt-drive unit 224. In this illustrated embodiment of the toolless securing pins 260A, 260B (collectively 260), the securing pins 260 are twistable pins that when twisted to a locked orientation, distal ends of the securing pins 260 are secured into a mating aperture within the belt drive units 222, 224. Likewise, when the securing pins 260 are twisted to an unlocked orientation, distal ends of the securing pins 260 are permitted to be released from their corresponding mating apertures, and thus the pins 260 removed from the belt drive units 222, 224 again without requiring the use of any tool in order to facilitate quick field disassembly of the unit 200.

In this embodiment, the mating apertures are formed within sides of the belt drive units 222, 224, but in other embodiments the securing pins 260 may be removably connected to another component or structure within the drive unit 200. Looking closer at the securing pins 260, their distal ends may include corresponding elongated tabs or pins 265A, 265B that are sized to pass into and out of corresponding slotted apertures to either release or secure the securing pins 260 in place, and thus secure or assist in releasing the upper and lower belt-side covers 230, 240. In this embodiment, the tabs 265A, 265B are configured such that a 90 degree rotation of the securing pins 260 defines the locked and unlocked orientations; however, other degrees of rotation may also be provided. Such securing pins 260 provide for quick and easy unlocking of the pins 260 from the drive unit 200, thus permitting quick removal of the belt-side covers 230, 240. Furthermore, springs may be provided within the heads (or under the heads, as illustrated) of each of the securing pins 260 to bias the heads outwardly from the belt-side covers 230, 240 when secured with the securing pins 260. This ensures the securing pins 260 do not come loose during use of the drive unit 200. In still other embodiments, the securing pins 260 may instead be threaded and thus configured to thread into corresponding threaded apertures, and thus the securing pins 260 are unthreaded to remove the covers 230, 240.

Also partially shown in FIG. 7 is the clamping mechanism 204A. As mentioned above, the clamping mechanism 204A is attached to the support wall 220A and belt-side cover 230 of the upper belt drive 222, and thus is employed to raise or lower the belt drive 222 to provide a clamping force to the lance hoses held between the upper and lower belt drive units 222, 224. The lower edge of the upper support wall 220A and the upper edge of the lower support wall 220B are configured to have a sliding relationship such that a structural relationship still exists between the upper and lower support walls 220A, 220B despite the vertical movement of the upper belt drive 222 with the clamping mechanism 204A. Similarly, the lower edge of the upper belt-side cover 230 and the upper edge of the lower belt-side cover 240 may also be configured to have a sliding relationship such that a structural relationship remains between the two covers 230, 240 throughout the range of vertical movement of the upper belt drive unit 222 provided by the clamping mechanism 204A. Such a sliding relationship may also be provided between the front and rear edges of the upper belt-side cover 230 and grooves formed on the interiors of the front and rear walls 208, 210 within the interior sidewalls of the slidable locks 250. Thus, while a slidable movement of the front and rear edges (including the tabs 230B and notches 230C) is provided in such grooves, the upper and lower cams 250C, 255C still retain the upper and lower covers 230, 240 to the unit 200 when the slidable locks 250 are maintained in their locked position (e.g., upward in this embodiment) and secured as such with the upper and lower fasteners 250A, 255A, and pins 250B.

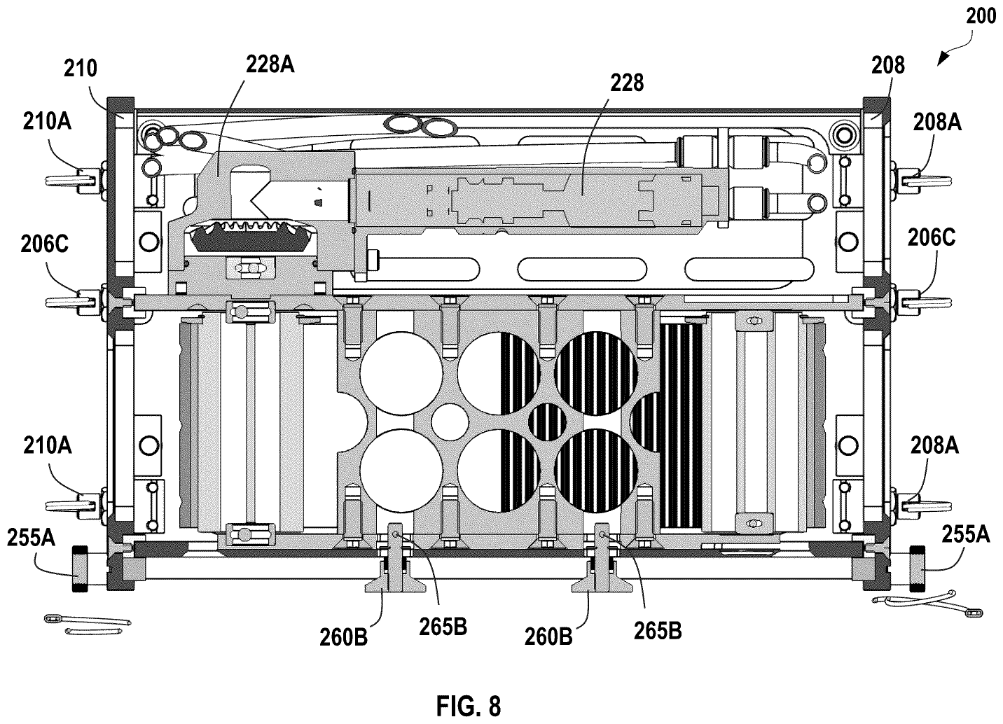

Looking now at FIG. 8, illustrated is a sectional view of a bottom portion of the drive unit 200 illustrated in FIG. 7. This sectional view further illustrates the lower set of securing pins 260B, which are also illustrated in cross-section. Also shown are the elongated tabs or pins 265B positioned near the distal ends of the securing pins 260B. In addition, in some embodiments, the far distal ends of these securing pins 260A, 260B are positioned within apertures formed in the sides of the belt drive units 222, 224, which assists in providing support for the belt drive units 222, 224. Specifically, the middle portion of the securing pins 260A, 260B may contact apertures formed in the belt-side covers 230, 240, while the distal ends of the securing pins 260A, 260B contact apertures, e.g., via clearance fit, in the belt drive units 222, 224, thereby providing a structural connection between the covers 230, 240 and their respective belt drive units 222, 224.

Turning finally to FIG. 9, illustrated is a partially transparent view of the belt-side of the drive unit 200. Support members 275A, 275B are affixed to the tops of the front and rear walls 208, 210, and top plate 204, of the drive unit 200, and the actuator, in the form of clamping mechanism 204A, is provided between these support members 275A, 275B. Support member 275B is shown transparent in FIG. 9, as is the near sidewall of the clamping mechanism 204A, to permit easier viewing of the interior of the clamping mechanism 204A.

As shown in this embodiment, the assembly of the clamping mechanism 204A includes three pistons 270, as well as position housing and cover surrounding the pistons and other internal components of the clamping mechanism. 204A. Top ends 270A of the pistons 270 may be secured to the top cover 204, for example, using screws or similar fasteners. The piston housing and cover move vertically, for example, from a pneumatic driving force, in relation to the top plate 204, thus moving the entire upper belt drive unit 222 vertically with respect to the lower belt drive unit 224. Pins 230A are positioned through the piston housing of the clamping mechanism 204A, the upper cover 230, and upper support plate 220A as well. Retractions springs 270B are provided around each of the pistons 270 to provide a return force during use of the clamping mechanism 204A. As discussed above, the lower edge of the upper support plate 220A maintains a slidable connection with the top edge of the lower support plate 220B, and the bottom edge of the upper belt-side cover 230 maintains a slidable connection with the top edge of the lower belt-side cover 240, and the upper belt drive unit 222 is vertically moved by the actuator 204A during use of the drive unit 200. While the clamping mechanism 204A in this embodiment is shown as a pneumatically driven mechanism, other drive types are also possible. For example, the clamping mechanism 204A may be hydraulically driven or electrically driven, as well as any other advantageous drive technology.

While this disclosure has been particularly shown and described with reference to preferred embodiments, it will be understood by those skilled in the pertinent field art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

What is claimed is:

1. A flexible high pressure fluid cleaning lance tractor drive apparatus, comprising:
a housing comprising:
a front wall, a rear wall, and a top cover coupled to top ends of the front and rear walls,
a bottom cover removably coupled to bottom ends of the front and rear walls, and
a motor-side cover coupled to a side edge of at least one of the front wall, rear wall, and top cover;
an upper belt drive unit and a lower belt drive unit both positioned within the housing, the upper and lower belt drive units configured to drive movement of at least one lance hose positioned between the upper and lower belt drive units;
an actuator coupled between the top cover and the upper belt drive unit, and configured to provide vertical movement of the upper belt drive unit;
a belt-side cover removably coupled to the upper belt drive unit, the belt-side cover configured to move vertically with the upper belt drive unit; and
wherein the upper and lower belt drive units are slidably coupled at their front ends within a front channel formed on an interior surface of the front wall, and slidably coupled at their rear ends within a rear channel formed on an interior surface of the rear wall; and
wherein one or more fasteners positioned at lower portions of the front and rear walls are configured to retain the upper and lower belt drive units within the front and rear channels.

2. The lance tractor drive apparatus of claim 1, wherein each of the upper and lower belt drive units comprises:
a support wall defining a belt side and a motor side, wherein a front edge of the support wall comprises the front end slidably coupled with the front channel, and a rear edge of the support wall comprises the rear end slidably coupled with the rear channel;
on the belt side of the support wall, an endless belt mounted on at least one drive roller and at least one idle roller; and
on the motor side of the support wall, a motor corresponding to each of the at least one drive roller and having a drive shaft configured to turn a corresponding drive roller for moving the endless belt.

3. The lance tractor drive apparatus of claim 2, wherein a bottom edge of the support wall of the upper belt drive unit is configured to slidably engage a top edge of the support wall of the lower belt drive unit.

4. The lance tractor drive apparatus of claim 2, wherein the motor is substantially perpendicular to a rotational axis of the corresponding drive roller, and further comprising a gearbox having an input receiving the drive shaft and an output rotating the corresponding drive roller.

5. The lance tractor drive apparatus of claim 1, wherein the actuator is a pneumatic clamping mechanism.

6. The lance tractor drive apparatus of claim 1, wherein the belt-side cover comprises an upper portion and a lower portion, wherein a bottom area of the upper portion is configured to slidably engage a top area of the lower portion, and wherein only the upper portion is removably secured to the upper belt drive unit.

7. The lance tractor drive apparatus of claim 6, further comprising at least one pin coupled to the actuator and slidably passing through a corresponding at least one aperture in the support wall of the upper belt drive unit.

8. The lance tractor drive apparatus of claim 1, further comprising at least one toolless fastener securing a front end of the bottom cover to a bottom end of the front wall, and at least one toolless fastener securing a rear end of the bottom cover to a bottom end of the rear wall.

9. The lance tractor drive apparatus of claim 8, wherein the at least one toolless fastener securing the front end of the bottom cover and the at least one toolless fastener securing the rear end of the bottom cover each comprise removable pins slidably passing through corresponding apertures in the front and rear walls, and sized for clearance fit within corresponding apertures in the front and rear ends of the bottom cover.

10. The lance tractor drive apparatus of claim 8, wherein the bottom cover further comprises a bottom channel on its interior surface extending longitudinally at least partially between its front end to its rear end, and sized to removably receive a bottom edge of the lower belt drive unit.

11. The lance tractor drive apparatus of claim 1, further comprising a removable toolless fastener passing through a bottom end of the front wall at a terminal end of the front channel, and a removable toolless fastener passing through a bottom end of the rear wall at a terminal end of the rear channel, the removable toolless fasteners positioned in the front and rear walls to prevent sliding withdrawal of the upper and lower belt drive units from within the front and rear channels.

12. The lance tractor drive apparatus of claim 1, further comprising a lance hose guide entrance manifold coupled to an exterior of the rear wall and configured to position the at least one lance hose between the upper and lower belt drive units, and a lance hose guide exit manifold coupled to an exterior of the front wall and configured to position the at least one lance hose when exiting from the housing.

13. A flexible high pressure fluid cleaning lance tractor drive apparatus, comprising:
a housing comprising:
a front wall, a rear wall, and a top cover coupled to top ends of the front and rear walls,
a bottom cover removably coupled to bottom ends of the front and rear walls, and
a motor-side cover coupled to a side edge of at least one of the front wall, rear wall, and top cover;
upper and lower belt drive units vertically positioned within the housing, and configured to drive movement of at least one lance hose positioned within the housing between the upper and lower belt drive units, wherein each belt drive unit comprises:
a support wall defining a belt side and a motor side, wherein a front edge of the support wall is slidably coupled with a front channel on an interior of the front wall, and a rear edge of the support wall is slidably coupled with a rear channel on an interior of the rear wall,
on the belt side of the support wall, an endless belt mounted on at least one drive roller and at least one idle roller, and
on the motor side of the support wall, a motor corresponding to each of the at least one drive roller and having a drive shaft configured to turn a corresponding drive roller for moving the endless belt;
an actuator coupled between the top cover and the upper belt drive unit, and configured to provide vertical movement of the upper belt drive unit; and
a belt-side cover removably coupled to the upper belt drive unit, the belt-side cover configured to move vertically with the upper belt drive unit;
wherein a bottom area of the support wall of the upper belt drive unit is configured to slidably engage a top area of the support wall of the lower belt drive unit; and
wherein the bottom cover comprises a bottom channel on its interior surface extending longitudinally at least partially between its front end to its rear end, and sized to removably receive the bottom edge of the support wall of the lower belt drive unit to provide structural support therefor.

14. The lance tractor drive apparatus of claim 13, further comprising at least one toolless fastener coupled to the actuator and slidably passing through a corresponding at least one aperture in the support wall of the upper belt drive unit, said pin configured to receive a removable tool to secure the belt-side cover to the upper belt drive unit.

15. The lance tractor drive apparatus of claim 13, further comprising at least one toolless fastener securing a front end of the bottom cover to a bottom end of the front wall, and at least one toolless fastener securing a rear end of the bottom cover to a bottom end of the rear wall.

16. The lance tractor drive apparatus of claim 13, wherein each motor is substantially perpendicular to a rotational axis of the corresponding drive roller, and further comprising a gearbox having an input receiving the drive shaft and an output rotating the corresponding drive roller.

17. The lance tractor drive apparatus of claim 13, wherein the actuator is a pneumatic clamping mechanism.

18. The lance tractor drive apparatus of claim 13, wherein the belt-side cover comprises an upper portion and a lower portion, wherein a bottom area of the upper portion is configured to slidably engage a top area of the lower portion, and wherein the upper portion is removably secured to the upper belt drive unit.

19. The lance tractor drive apparatus of claim 13, wherein at least one toolless fastener securing the front end of the bottom cover and the at least one toolless fastener securing the rear end of the bottom cover each comprise removable pins slidably passing through corresponding apertures in the front and rear walls, and sized for fit within corresponding apertures in the front and rear ends of bottom cover.

20. The lance tractor drive apparatus of claim 13, further comprising a removable toolless fastener passing through a bottom end of the front wall at a terminal end of the front channel, and a removable toolless fastener passing through a bottom end of the rear wall at a terminal end of the rear channel, the removable toolless fasteners positioned in the front and rear walls to prevent sliding withdrawal of the upper and lower belt drive units from within the front and rear channels.
